(19) United States
(12) Patent Application Publication
(10) Pub. No.: US 2024/0220421 A1
(43) Pub. Date: Jul. 4, 2024

(54) Small Footprint Reference-Counting Buffer Pool Management Without Synchronization Locks

(71) Applicant: Eric Howard Welch, Berkeley, CA (US)

(72) Inventor: Eric Howard Welch, Berkeley, CA (US)

(73) Assignee: Bramson Welch & Associates, Inc, (omitted)

(21) Appl. No.: 18/149,093

(22) Filed: Dec. 31, 2022

(51) Int. Cl. G06F 12/123

(52) U.S. Cl. CPC G06F 12/123

(57) ABSTRACT

A centralized small footprint, reference counted, buffer pool management scheme is supplemented by a system of pairs of read and write FIFOs to coordinate the central thread and non-central threads and interrupt handlers without the need for synchronization locks or disabling of interrupts. The buffer pool comprises a plurality of different sized buffers. Buffers are organized onto queues and a reference count maintained to track when buffers are placed onto more than one queue at a time. This scheme minimizes buffer copy, promotes fast access and deterministic interrupt handling time. An additional mechanism is presented for exception signaling and event handling that also works without synchronization locks or the disabling of interrupts.

### REFERENCE TO RELATED PATENTS

| | | | | |
|---|---|---|---|---|
| 7,769,791 | B2 | August 2010 | Doherty et al | 707/814 |
| 7.194,495 | B2 | March 2007 | Moir et al | 707/206 |
| 6,144,965 | | November 2000 | Oliver et al | 707/100 |
| 8,499,137 | B2 | July 2013 | Hasting et al | 707/813 |

### BACKGROUND OF INVENTION

### 1. Field of Invention

a. Numerous schemes exist for memory and buffer management, using reference counting and garbage collecting. These schemes usually require synchronization locks to prevent the corruption of data when accessed by multiple threads and interrupt handlers. Some of these schemes have high time and/or space overhead and can lead to priority inversion between threads.

b. When employed in interrupt handlers, these synchronization locks are costly and often operate at the expense of the response time for high priority interrupts and threads.

### 2. Description of Related Art

a. Doherty (791) describes a reference counted system using microprocessor synchronization techniques such as compare-and-swap. While these maintain integrity of the objects in question, the process that doesn't get access to the object in question (i.e. the reference count value) still has to wait for an unknown amount of time to complete its work, potentially resulting in performance reduction.

b. Moir (495) presents a number of algorithms for optimized interaction using light weight synchronization primitives.

c. Oliver (965) presents a scheme for managing objects with reference counts but doesn't address synchronization logic.

d. Hasting (137) describes a memory management scheme for communication processors that uses reference counting. However, thread and interrupt synchronization isn't addressed.

### SUMMARY OF THE INVENTION

The present invention is a small foot print, highly efficient, reference counted, centralized buffer management system. All direct accesses to this system are staged in a main processing thread, from which location all accesses are serialized, eliminating the need for Locks. All other threads operate on buffers which are passed in and out using a system of FIFOs, between the given thread and the Central thread. When a thread wants to pass a buffer somewhere else, it is placed onto the Central-bound FIFO with a command indicating its disposition (i.e. Release, placement on one or more Queues, etc.). In this manner, the FIFO operates as a Remote Procedure Call. Also, since the particular FIFO design herein requires no Synchronization Locks for itself and the buffer management system runs in only one thread, no Synchronization Locks are required anywhere. In addition this invention includes an exception processing scheme that disrupts the regular flow, but which also requires no synchronization locks.

As an alternative to solutions for the general “value recycling problem” or related memory management challenges, the present invention includes an architectural approach where access to the memory management data structures are serialized in a central thread and other processing threads access the shared data space via FIFO messages without the need for synchronization locks or risk of priority inversion. As will be shown, this scheme also imposes no performance or memory penalty.

This approach provides all of the advantages of a shared memory buffer pool including data reuse with reference counting, minimized buffer copy and immediate, deterministic access to data free of synchronization locks or disabling of interrupts.

### BRIEF DESCRIPTION OF THE DRAWINGS

FIG. 1 shows a simple queue data structure with “First Ptr” (101) and “Last Ptr” (102) pointers and a “Count” (103) of items linked to the queue.

FIG. 2 shows a linked list of queue items (“Qi”) on a simple queue that has “first” and “last” pointers. Each Qi has a “next” pointer that is either the next item or is NULL for the last or the list.

FIG. 3 is a simple queue item showing a “next” (301) pointer, “length” (302) and “payload” (303) with <length>bytes

FIG. 4 is a Buffer Select object with Qi Ptr (401) and Next Ptr (402)

FIG. 5 shows a scheme where the linked list connected directly to a given queue is a list of Buffer Select (“bS”) objects (502, 503, 504, 508 and 509). Each Buffer Select (“bS”) object in turn points to a queue item (“Qi”, with buffer payload). In this way a given Qi can be on multiple Queues at once. Each Qi has a reference count giving the number of separate Queues that the item is on.

FIG. 6 is a Qi object with fields Type, Index, Length, Reference, and Payload buffer

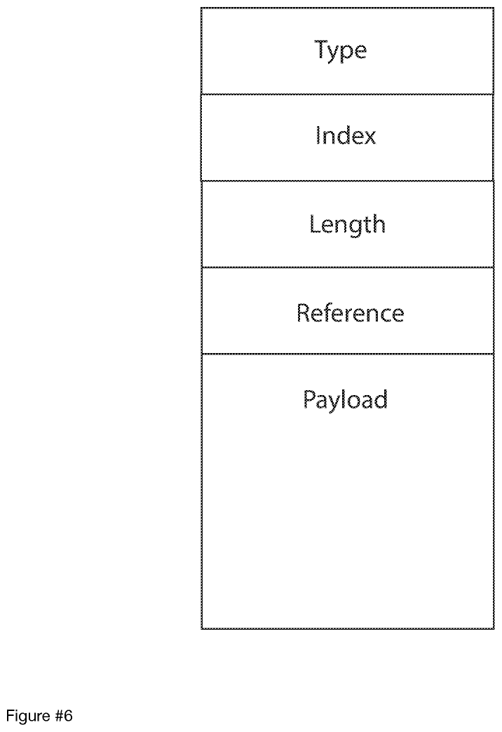

FIG. 7 is the Buffer Select free pool, with First (701) and Last (702) pointers as in the simple queue of FIG. 1 and the Buffer Select objects (703, 704 and 705) are an example the objects on this linked list. The actual number will vary.

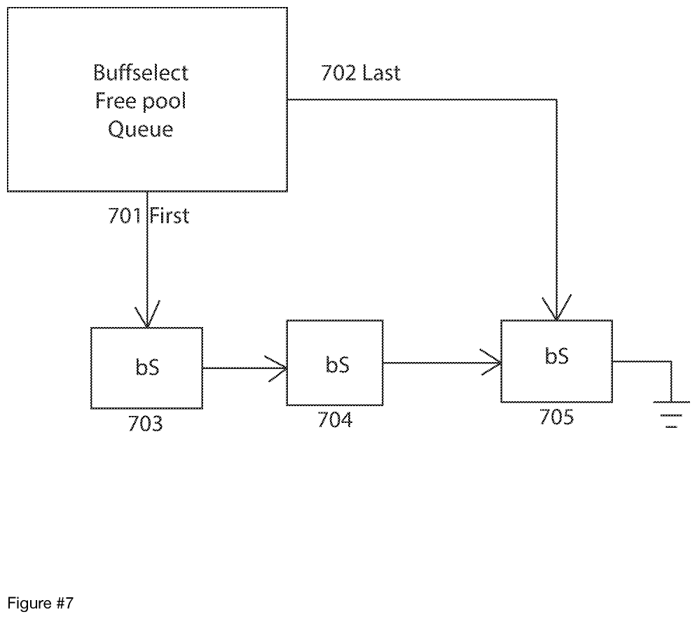

FIG. 8 is an example of messages on two queues where main content (810, 811 and 812) is shared but the message headers (809 for message 1, 819 for message 2) and trailers (808 for message 1 and 814 for message 2) are separate

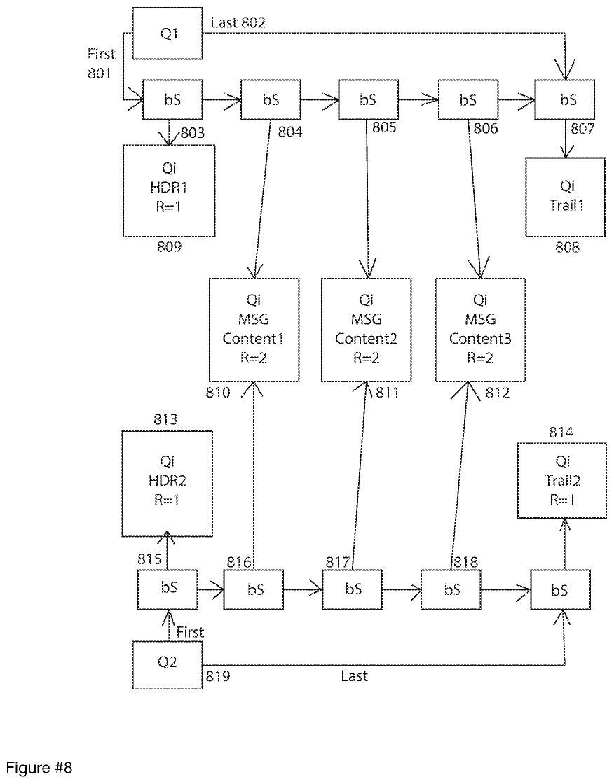

FIG. 9 is the FIFO scheme for sending command and buffer references between threads. (FIFO (901), IN (902) and OUT (903)). Each element in the FIFO is a FIFO Item comprising the fields Command, Reference and Qi Ptr.

FIG. 10 is a flow chart of a read interrupt handler

FIG. 11 is a flow chart of an example main thread forwarding logic

### DESCRIPTION OF THE INVENTION

### Overview

The buffer Queue system described herein has several components.
a. All buffers are implemented as Queue Items, initially on a Free Pool.
b. Queues are of two types: Simple and Reference Counted.
c. Buffer Select items are used in the Reference Counted Queue to facilitate a given Queue Item being on more than one queue at a time.
d. FIFOs are used to transmit Queue Items between threads without Synchronization Locks.
e. The inter-thread exception scheme uses the concept of an exception event as a single time-domain pulse with a rising and falling edge where the pulse width is selected to be slightly larger than the processing time of the higher priority thread's exception code path.

### Terminology

| Term | Definition |
|---|---|
| Queue | Linked list head with First and |
| | Last pointers and a count |
| FIFO | Structure of fixed size comprising |
| | FIFO Elements |
| FIFO element | Element of FIFO containing fields |
| | Command, Reference Qi Ptr |
| Queue Item | Buffer with fields Type, Reference, |
| (“Qi”) | Length, Index and Payload |
| First Ptr | Field that points at the first item in a linked list |
| Last Ptr | Field that points at the last item in a linked list |
| Next Ptr | Field that points at the next item in a linked list |
| Freepool | Designated Queue that uses bSelects to |
| | hold all unused Qis of a given size |
| Buffer Select | Element in linked list that organizes |
| (bSelect or bS) | Qis onto a given Queue |
| Null | The null pointer, a pointer to nothing |

Simple Queue Scheme

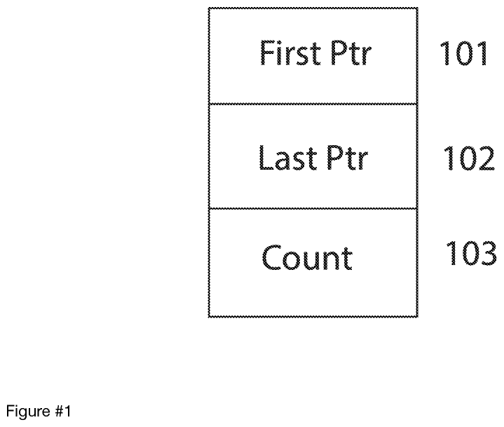

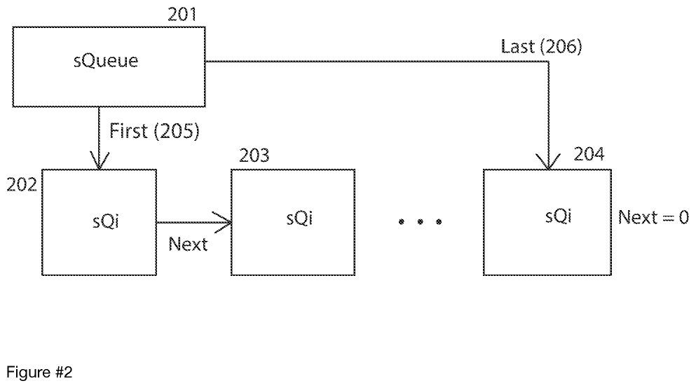

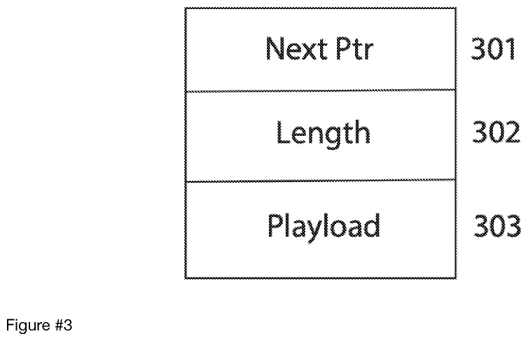

As shown in FIGS. 1-3, a traditional linked list buffer queue system, especially in data communications or data acquisition is often a first in first out sQueue. Data is stored in sQueue Items (“sQi”) and are stored in a queue by linking sQi's as follows (201) such that the sQueue first (101) pointer points at the first sQi (202), each sQi's next pointer (301) points to the next sQi where the last sQi's next pointer is NULL. The sQueue Last pointer (103) also points at this last sQi.

The sQueue is accessed First-In-First-Out where new items are added to the end and last item's Next (301) and the Queue Last (103) pointers updated.

The Buffer Select objects described below are managed in a free pool using the simple scheme.

Simple Add to Queue
a. if sQueue.First (205) is zero, set sQueue.First (205) and sQueue.Last (206) to be a pointer to sQi ands Qi.Next (301) to Null
b. Otherwise set the sQi.Next pointed to by Last (206) to be a pointer to sQi and update Last (206) to new sQi
c. Increment sQueue Count

Simple Removal
a. Removed item Qi is at Queue.First (205) (could be Null if Queue is empty
b. Set Queue.First (205) to Qi.Next (301). If zero, also set Queue. Last (206) to Null.
c. Decrement q count

Free pool. A special queue that holds all initial items. Obtaining a usable queue item requires removing it from the Freepool. When one is no longer needed, it is freed by putting it back onto the Freepool.

No garbage collection

Reference counted Queue scheme

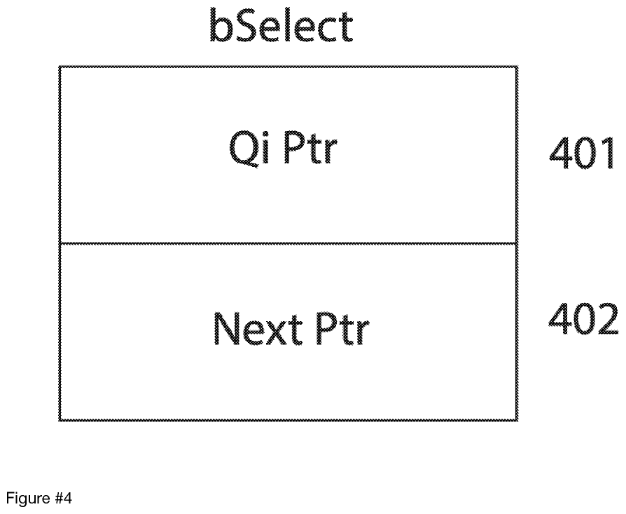

Queue Items Buffers (Qi) are organized onto one or more Queues using the intermediate Buffer Select (FIG. 4) object, also called “bSelect” or just “bS”.

All available memory for buffer management is preallocated into:
a. Space for Buffer Select objects, organized on a simple queue Freepool. The number of Buffer Selects is at least as large as the total number of Qis, plus additional Buffer Selects for the expected number of Qis stored on multiple Queues at one time
b. Space for Buffers (Qis) where each different type is a different size, say 16 bytes, 64 bytes and 256 bytes, etc.
c. Space for one Freepool Queue for each different type. The Freepools are Reference Counted Queues

To Add Qi to Queue (reference)
a. Allocate one bSelect from its Freepool using “Simple Removal”. If none available, error. Set bSelect.Qi pointer (401) to Qi and bSelect.next to Null
b. If Queue.First (205) is zero, set Queue.First (205) and Queue.Last (206) to be a pointer to bSelect
c. Otherwise set the bSelect.next (402) pointed to by Queue.Last (206) to be a pointer to the new buffSelect and update Queue. Last (206) to the new bSelect

Remove from Queue (reference)
a. If Queue.First (101) is Null, Queue is empty, return Null
b. Otherwise, Set variable bSp to Queue.First (101)
c. Set Queue.First (101) to bSp.Next (402)
d. If the resulting Queue.First (101) is Null, set Queue. Last (102) to Null
e. Set Qi to bSp. Qi Ptr (401)
f. Free bSp using Simple Add to Queue above for Buff Select Freepool
g. Return Qi

Retain Qi
a. Increment Q.Reference (502)

Free/Release Qi
a. Decrement Qi.Reference (502)
b. If zero, add Qi to Freepool for its type

Allocate Qi by size
c. Locate Freepool for indicated size, or first Freepool is no size indicated
d. If empty, no items available for indicated size, return Null
e. Otherwise obtain Qi by using Remove from Queue with the Freepool for that size
f. Set Qi.Reference (502) to one
g. Return Qi

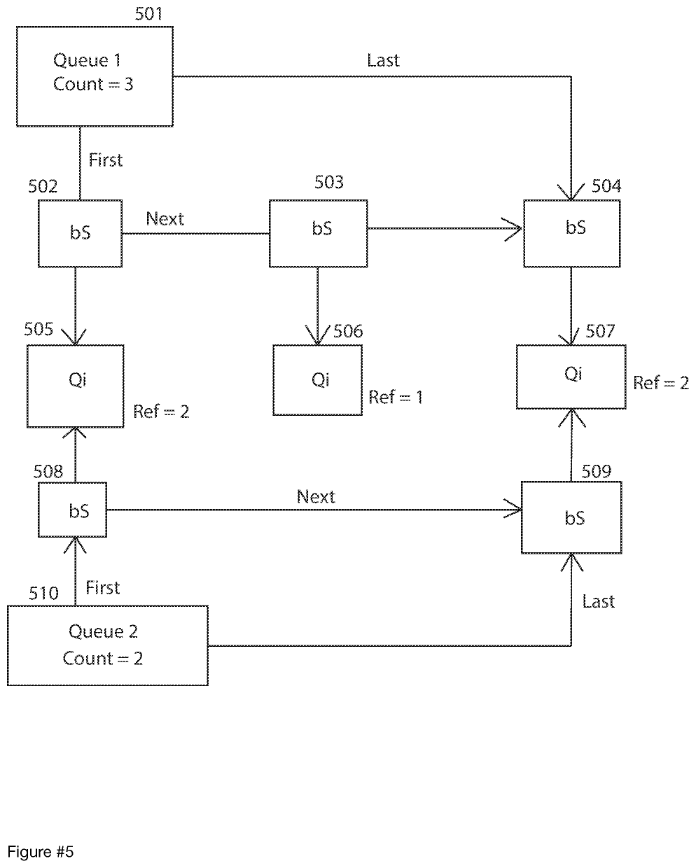

To put Qi onto more than one queue (FIG. 5)
h. Upon initial allocation, Qi.Reference (502) is one
i. Add to first Queue (501), Qi.Reference (502) is still one
j. To add to any additional queue, execute Retain (Ref=2, 505) and then Add Qi to the additional Queue (510). This causes bS (508) to be allocated and linked onto second queue (510)
k. In multi-queue context, once an item is removed and no longer needed, call Release
l. Once Release is called with Retain=1, it is put back onto the free queue, since it is no longer being used.

This multi-queue scheme can be used in a communications system when a given message needs to be queued for transmission onto multiple different ports. Since each port will in general be under the control of a different protocol context, it will need different message headers and/or trailers. As indicated on drawing #8, this is accomplished by having separate message headers (809 and 813) and/or trailers (808 and 814) Qis allocated separately for each interface. In this way, each interface has its own message with the required protocol formatting, but the message content (810, 811 and 812) is shared between the separate queues.

### Lock Free Synchronization

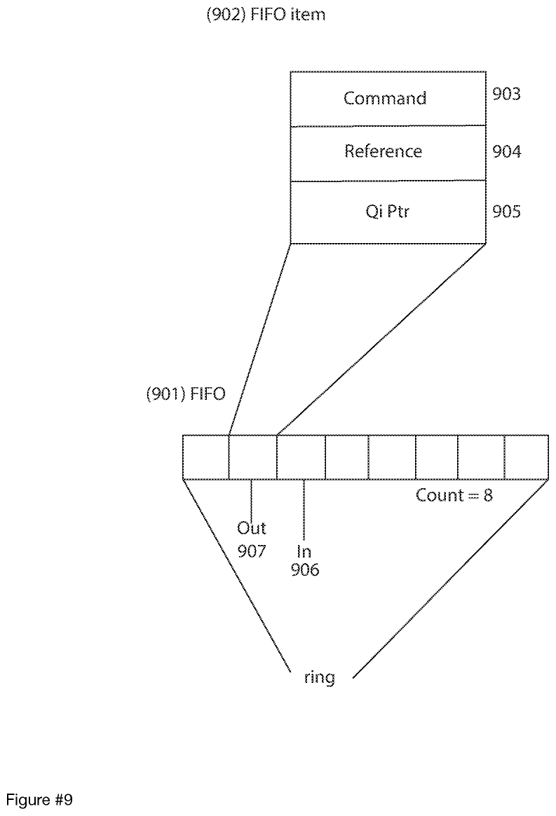

A FIFO (FIG. 9) is a Lock free mechanism used to send simple messages in one direction between two different threads. Two FIFOs can be created between any two threads to send messages in both directions. Multiple writers and readers in each thread can be accommodated on a first come first served basis because by being on one thread their access to the FIFO is serialized.

The FIFO is preallocated to a known size (Count) and is comprised of the following elements
a. The FIFO storage contains Count FIFO Items
b. IN index (an integer between zero and Count-1)
c. OUT index (an integer between zero and Count-1)

Each FIFO Item contains:
a. Command
b. Reference
c. Qi pointer

When allocated, the FIFO storage has exactly space for Count FIFO items. IN and OUT are initially zero. Whenever IN is equal to OUT, the FIFO is empty. In order to write an item, the sender stores that item at FIFO[IN] and then increments IN by 1 modulo Count. The order of processing is important, the increment on IN must be the last step. To prevent overflow, IN must not be modified such that it becomes equal to OUT.

To read from the FIFO, the receiver checks that IN is not equal to OUT and if it is, takes the next element from FIFO[OUT]. It then increments OUT by 1 modulo Count. If this item was the last, IN will then be equal to OUT.

Because exactly one thread modifies either IN or OUT but not both, the mechanism is thread save without a Synchronization Lock. Space in the FIFO can be thought of as divided into empty and filled. The sender writes into the empty space and as its last action, updates IN, effectively moving that item from the empty to the filled part of the FIFO. Correspondingly, the receiver removes the item at the offset OUT and updates OUT as its last act, moving that item from the filled to the empty area.

To support the centralized buffer management scheme, a pair of FIFOs (one for each direction) is allocated between each non-central and the central thread. Elements on these FIFOs comprise:
a. A Pointer to a buffer
b. A command
c. An optional Reference

In a communications system, the low level (or interrupt) threads generally operate on one or more buffers at a time, either transmitting from one that is full or partially full, or receiving into one that started empty. The transmit thread will get data to send from buffers pointed to by elements in its inbound FIFO. When complete the transmit thread then places used buffers in its outbound FIFO. Similarly, read threads (data communications or data acquisition) will obtain empty buffer pointers from its inbound FIFO and place filled buffers on its outbound FIFO.

Since management of the pointers in the queue system is only done in a single thread, ie the central thread, and because the other threads only interact with queue items on FIFOs, no disabling of interrupts or thread synchronization is needed.

### Lock Free Exception Processing

There is a special case for read threads where some exception is required to the normal processing flow, such as a timeout forwarding. For example, a character interrupt handler fires for each character and saves it into a waiting queue item buffer. When that buffer is full, it is forwarded by placing it on that handler's outbound FIFO and obtaining another empty buffer from its inbound FIFO. However, it is often desirable that a partially filled buffer be “forwarded” if some number of idle character times pass since the last received character.

This special out-of-sequence processing can be handled by defining another special “exception” inbound FIFO where the central thread can “take” a partially filled buffer, bypassing the handler's outbound FIFO by first sending a “forward” command in the exception FIFO. In this way, the next time there is a character interrupt, the handler will first check the exception FIFO and race conditions are avoided.

To facilitate this without a Synchronization Lock or by disabling interrupts, the exception condition can be thought of as a time domain pulse with a rising edge slightly before the condition obtains and a falling edge when it does obtain.

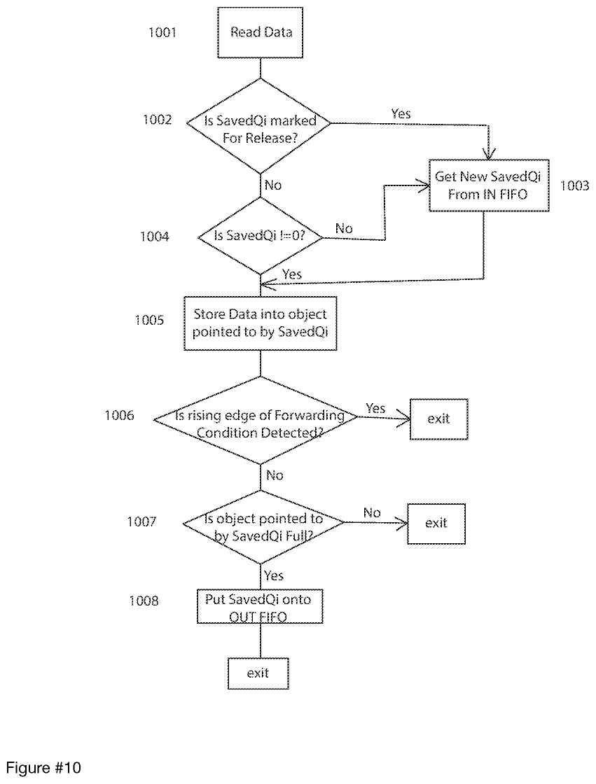

FIG. 10 presents an example of one high priority thread or interrupt handler that reads one data item (1001) and saves it (1005) in a waiting buffer (SavedQI). When SavedQI is full (1007) it is forwarded (1008). If there is no waiting buffer (1004), a new empty one is taken from the In FIFO (1003).

If SavedQI is marked for release (1002) because a release command for that buffer is found on the Ex FIFO, a new buffer is allocated (1003) and the old one ignored. If the rising edge or high state of the forwarding condition is detected (1006) after the data is saved, exit.

In pseudo code:
a. Read character
b. Is there a Release command for SavedQi in the ExRxFIFO or is there no SavedQi?
c. If so, Get a new SavedQi from the InFIFO
d. Store Character in SavedQi
e. Has rising Edge or High state of Forward Condition obtained?
f. If so, exit
g. Otherwise, is SavedQi full:
h. If so, forward by placing onto OutFIFO and zeroing SavedQi

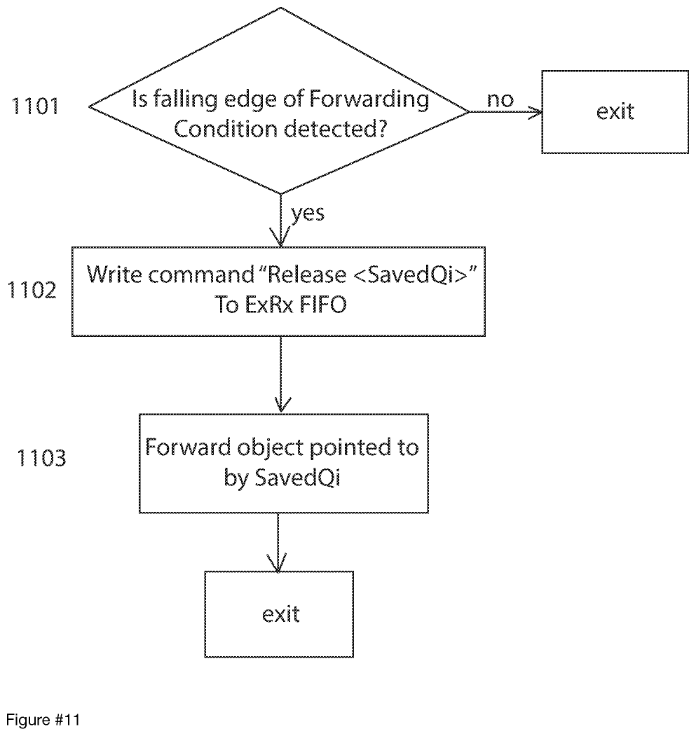

FIG. 11 presents an example of the main thread forwarding logic. In (1101) it checks for the falling edge of the forwarding condition and exits if not found. If the exception falling edge is found then write the Release message into the Ex FIFO and forward saveQi. If the FIG. 10 handler runs at point 1101, then it saves a character. If it sees the rising edge of the forwarding condition, it exits. Otherwise, it writes the buffer into the OUT FIFO, if required.

The interrupt handler will process normally (character saved) and unless the rising edge is detected it will forward if required. In the main logic, if the falling edge is detected, the interrupt handler will see the rising edge and save the data but won't forward. If it fires at 1103 or 1104, the interrupt handler will get the release message and save any new data in a new SavedQi.

The only potential risk of interaction between the two threads is around the forwarding event. The forwarding event's rising edge signals the handler that it can save data into the current buffer but that it shouldn't forward it. The SavedQi is guaranteed to have space otherwise it would have been forwarded on the last round when it became full. The forwarding event's falling edge means that the central forwarding logic can forward the buffer without concern for interference from the interrupt handler which may have not fired at all, but if it did it would only save into the current buffer but not forward. Forwarding is then handled by the central thread.

A POSITA would understand that the read interrupt handling case presented here is only an example and that this exception handling scheme without synchronization locks could be applied to other cases, for example, Forward Reset.

Forward Reset is an event where a thread or interrupt handler is sending data from a buffer received on its inbound FIFO. Normally this would complete and the sent buffer would placed on its outbound FIFO. If the exception rising edge is detected and there is a reset command in the exception command queue, no more data is sent from the referenced buffer and it is placed onto the Outbound FIFO.

Systems of two FIFOs between any two threads, not just where one is the Central Thread, are also possible allowing a plurality of non-central threads to communicate directly without the Central Thread and without synchronization locks.

What is claimed is:

1. A method for centralized reference counted buffer management where FIFOs are used to send messages and buffer pointers between threads, without locks, the method comprising:
(i) The management scheme is comprised of a plurality of different sized pre-allocated buffers and a plurality of linked list Queues. The items in the linked list Queue are a plurality of Buffer Selects, each of which points to a) a Buffer and b) the next Buffer Select (or Null if end). One Free Pool Queue is allocated for each different buffer size. Each buffer includes fields for its size, type, Reference count, Length and Index. Buffers are allocated by size.
(ii) Each buffer can appear on more than one Queue by the use of intermediate Buffer Select elements linked onto each Queue where each points to an individual buffer. The Buffer's Reference count is modified to track the number of uses via Retain and Release functions. When Release is called with a Reference count of one, the buffer is replaced onto the Freepool for its size.
(iii) A FIFO is allocated for a number of elements (each containing a buffer pointer and a command) and connects exactly two threads for unidirectional message sending. The FIFO is initially empty and one or a plurality of elements are added up to the limit of the pre-allocated size. Items are removed or read out in the order that they were added.
(iv) The FIFO IN and OUT offset define how much of the FIFO is used where IN equal to OUT indicates empty. The sender adds to the FIFO at IN and increments IN modulo FIFO Size. The receiver removes elements at OUT and increments OUT modulo FIFO Size. Because different pointer offsets are used in each of the two different threads, no additional synchronization logic or disabling of interrupts is required to maintain the integrity of the data structure.
(v) A Central thread manages the buffer pool and sends/receives messages via FIFOs with non-Central threads and interrupt handlers. Only the Central thread moves buffers onto and off of the Queues. Two FIFOs are allocated for each, one inbound (from central) and one outbound (to Central)
(vi) A plurality of non-central threads send and receive Qis to/from the Central thread via FIFOs and use those buffers as required. A thread that originates data receives empty buffers on its In FIFO and a thread that processes data receives full or partially full buffers on its In FIFO. Processed buffers are sent back to the Central thread on the Out FIFO.
(vii) No Synchronization Locks are used.

2. The method of claim #1 with the addition of an exception-event characterized by signal pulse with a rising and falling edge close together.
(i) The exception signal pulse width is at least as long as the time required for the non-Central thread's single iteration.
(ii) This event has the operation of allowing the Central thread take control of the current buffer in use by the other thread.
(iii) This event is processed between threads by having the non-central thread detect the exception-event signal high and to operate normally except that it doesn't put the buffer onto its Outbound FIFO.
(iv) The Central Thread writes a FIFO element to a special Exception FIFO indicating that the buffer referenced in the element is subject to the exception control. The Central Thread takes control of the buffer in question after the falling edge of the exception-event pulse. No synchronizations Locks are required.

3. A computer-implemented API providing the following services.
(i) An Initialization call sets up the management scheme comprised of a plurality of different sized pre-allocated buffers and a plurality of linked list Queues. The items in the linked list Queue are a plurality of Buffer Selects, each of which points to a Buffer. One Freepool Queue is allocated for each different buffer size. Each buffer has its size, type, Reference count, Length and Index. Buffers are allocated by size.
(ii) A call to remove an item from a Queue. When the Queue is the Freepool, this call is used to allocate the item and its Reference count is set to one. The Buffer Select used to link the item on the queue is released back to its Freepool.
(iii) A call to place an item onto a Queue. This starts by allocating a Buffer Select from its special list and linking the Buffer Select onto the given Queue. The Buffer Select's Queue Item pointer is set to the item provided to the Call.
(iv) A Retain call that increments the Reference Count of the provided item. Each buffer can appear on more than one Queue by the use of intermediate Buffer Select elements linked onto each Queue where each points to an individual buffer. The Buffer's Reference count is modified to track the number of uses via Retain and Release functions.
(v) A Release call that decrements the Reference Count. When Reference Count is zero the buffer is replaced onto the appropriate Free Pool for its size.
(vi) A FIFO Initialization call allocates a FIFO with a given number of elements which doesn't change after being setup. Each FIFO element contains a buffer pointer and Command and optional Reference. The FIFO IN and OUT offset define how much of the FIFO is used where IN equals OUT indicates empty.
(vii) An Add-to-FIFO call adds a provided element to the FIFO at the IN position and increments IN modulo FIFO Size.
(viii) A Remove-from-FIFO Call removes and returns the element at OUT and increments OUT modulo FIFO Size. Because different pointer offsets are used in each of the two different threads, no additional synchronization logic or disabling of interrupts is required to maintain the integrity of the data structure.
(ix) A Central thread manages the buffer pool and sends/receives messages via FIFOs with non-Central threads and interrupt handlers. Two FIFOs are allocated for each, one inbound (from central) and one outbound (to Central).
(x) A non-Central thread calls Remove-from-FIFO with the Input FIFO to get a buffer from the Central thread. When complete the buffer is returned to the Central thread by calling Add-To-Fifo on the Outbound FIFO.
(xi) No Synchronization Locks are used.

4. A computer implemented API of claim 3 with the addition of an exception-event characterized by signal pulse with a rising and falling edge close together.
(i) The exception signal pulse width is at least as long as the time required for the non-Central thread's single iteration.
(ii) This event has the operation of allowing the Central thread take control of the current buffer in use by the other thread.
(iii) This event is processed between threads by having the non-central thread detect the exception-event signal high and to operate normally except that it doesn't put the buffer onto its Outbound FIFO.
(iv) The Central Thread writes a FIFO element to a special Exception FIFO indicating that the buffer referenced in the element is subject to the exception control. The Central Thread takes control of the buffer in question after the falling edge of the exception-event pulse. No synchronizations Locks are required.

5. A method for protecting data communication and acquisition processor buffer memory shared between threads without synchronizations locks.
(i) Buffer memory is organized into a plurality of groups of buffer blocks (Queue Item or Qi) each member of the group having the same size (indicated by Type). A plurality of groups exist each with a different size buffer block. Each buffer block has as data elements Size, Type, Reference count, Length, Index and payload. Buffers are allocated by size.
(ii) Queues organize references to the buffer blocks by using Buffer Selects in a linked list to identify the blocks on the given queue, where the Buffer Selects point to the actual buffer block. In this way, a given Buffer Block can be on multiple queues at once, with its Reference count indicating the number of such Queues.
(iii) A FIFO stores a pre-allocated number of elements (each containing a buffer pointer and a command) and connects exactly two threads for unidirectional message sending. A given FIFO starts empty and can be added to up to the limit of the pre-allocated size.
(iv) The FIFO IN and OUT offset define how much of the FIFO is used where IN equals OUT indicates empty. The sender adds to the FIFO at IN and increments IN modulo FIFO Size. The receiver removes elements at OUT and increments OUT modulo FIFO Size. Because different pointer offsets are used in each of the two different threads, no additional synchronization logic or disabling of interrupts is required to maintain the integrity of the data structure.
(v) A Central thread manages the buffer pool and sends/receives messages via FIFOs with non-Central threads and interrupt handlers. Only the Central thread moves buffers on and off of the Queues. Two FIFOs are allocated for each, one inbound (from central) and one outbound (to Central).

6. The method of claim 5 with the addition of an exception-event characterized by signal pulse with a rising and falling edge close together.
(i) The exception signal pulse width is at least as long as the time required for the non-Central thread's single iteration.
(ii) This event has the operation of allowing the Central thread take control of the current buffer in use by the other thread.
(iii) This event is processed between threads by having the non-central thread detect the exception-event signal high and to operate normally except that it doesn't put the buffer onto its Outbound FIFO.
(iv) The Central Thread writes a FIFO element to a special Exception FIFO indicating that the buffer referenced in the element is subject to the exception control. The Central Thread takes control of the buffer in question after the falling edge of the exception-event pulse. No synchronizations Locks are required.
